(19) United States
(12) Patent Application Publication
(10) Pub. No.: US 2026/0034879 A1
(43) Pub. Date: Feb. 5, 2026

(54) TRANSMISSION RATIO STABILIZATION APPARATUS AND METHOD ON LOW FRICTION ROADS

(71) Applicants: HYUNDAI MOTOR COMPANY, Seoul (KR); KIA CORPORATION, Seoul (KR)

(72) Inventors: Sejin Kim, Hwaseong-si (KR); Young Tae Kim, Hwaseong-si (KR); Ho Young Kim, Hwaseong-si (KR); Sunghwa Jeong, Hwaseong-si (KR)

(73) Assignees: HYUNDAI MOTOR COMPANY, Seoul (KR); KIA CORPORATION, Seoul (KR)

(21) Appl. No.: 19/042,593

(22) Filed: Jan. 31, 2025

(30) Foreign Application Priority Data
Jul. 30, 2024 (KR) 10-2024-0101100

(51) Int. Cl. B60K 28/16

(52) U.S. Cl. CPC B60K 28/16

(57) ABSTRACT

A transmission ratio stabilization apparatus includes a wheel speed sensing unit that senses a first wheel speed of a drive wheel and a second wheel speed of a non-driven wheel, respectively, in a vehicle; an accelerator sensing unit that senses vehicle acceleration that reflects a driver's intention to accelerate the vehicle; a wheel slip determination unit that determines whether wheel slip occurs based on the first wheel speed and the second wheel speed; and a target transmission ratio calculation unit that calculates a target transmission ratio based on the first wheel speed when the wheel slip does not occur. The target transmission ratio calculation unit calculates the target transmission ratio based on the second wheel speed when the wheel slip occurs.

### CROSS-REFERENCE TO RELATED APPLICATION

This application claims priority to and the benefit of Korean Patent Application No. 10-2024-0101100, filed on Jul. 30, 2024, the entire contents of which are incorporated herein by reference.

### BACKGROUND

### (a) Field

The present disclosure relates to a transmission ratio stabilization apparatus and method on low friction roads, and more particularly, to a transmission ratio stabilization apparatus and method that enable a vehicle to drive on the low friction roads.

### (b) Description of the Related Art

A transmission ratio of a vehicle using an automatic transmission is determined based on a speed of a transmission output shaft or a speed of a drive wheel.

When drive wheel slip occurs, the speed of the transmission output shaft increases significantly, so a target transmission ratio changes significantly according to the sudden change in reference vehicle speed, thereby making it difficult to control driving force, and when the drive wheel exits the low friction roads, there is a problem that the acceleration performance is not good due to the reduced transmission ratio.

The statements in this section merely provide background information related to the present disclosure and may not constitute prior art.

### SUMMARY

The present disclosure provides a transmission ratio stabilization apparatus and method on low friction roads capable of calculating a target transmission ratio based on a non-driven wheel even when wheel slip occurs on the low friction roads to stably maintain the transmission ratio, allowing an engine speed to be controlled as desired, similar to on flat ground.

According to an embodiment of the present disclosure, a transmission ratio stabilization apparatus includes: a wheel speed sensing unit that senses a first wheel speed of a drive wheel and a second wheel speed of a non-driven wheel, respectively, in a vehicle; an accelerator sensing unit that provides an accelerator pedal information that reflects a driver's intention to accelerate the vehicle; a wheel slip determination unit that determines whether wheel slip occurs based on the first wheel speed and the second wheel speed; and a target transmission ratio calculation unit that calculates a target transmission ratio based on the first wheel speed when the wheel slip does not occur. The target transmission ratio calculation unit calculates the target transmission ratio based on the second wheel speed when the wheel slip occurs.

The wheel slip determination unit may determine that the wheel slip has occurred when the first wheel speed increases while the second wheel speed maintains its current speed. The wheel slip determination unit may determine that the wheel slip has not occurred when the first wheel speed and the second wheel speed are maintained the same.

The target transmission ratio calculation unit may calculate the target transmission ratio based on either the first wheel speed or the second wheel speed and the accelerator pedal information.

The target transmission ratio calculation unit may calculate a target transmission ratio of an automatic transmission (AT), a dual clutch transmission (DCT), or a continuously variable transmission (CVT) of the vehicle.

The transmission ratio stabilization apparatus may further include a transmission input/output speed sensing unit that senses a first transmission output speed based on the drive wheel and a second transmission output speed converted based on a vehicle speed based on the non-driven wheel. The transmission input/output speed sensing unit may calculate the second transmission output speed, which is a virtual driven pulley speed value, using a final gear ratio (FGR) and a tire dynamic radius based on the vehicle speed based on the non-driven wheel.

When the wheel slip does not occur, the target transmission ratio calculation unit may calculate, as the target transmission ratio, a value by dividing a first target drive pulley speed calculated based on the first wheel speed and the accelerator pedal information by a vehicle speed or the first transmission output speed based on the drive wheel.

When the wheel slip occurs, the target transmission ratio calculation unit may calculate, as the target transmission ratio, a value by dividing a second target drive pulley speed calculated based on the second wheel speed and the accelerator pedal information by the vehicle speed based on the non-driven wheel.

When the wheel slip occurs, the target transmission ratio calculation unit may calculate, as the target transmission ratio, a value by dividing a second target drive pulley speed calculated based on the second wheel speed and the accelerator pedal information by the second transmission output speed.

According to another embodiment of the present disclosure, a transmission ratio stabilization method on low friction roads includes: sensing a first wheel speed of a drive wheel and a second wheel speed of a non-driven wheel, respectively, in a vehicle; providing accelerator pedal information corresponding to vehicle acceleration desired by a driver of the vehicle; determining whether wheel slip occurs based on the first wheel speed and the second wheel speed; and calculating a target transmission ratio based on the first wheel speed when the wheel slip does not occur, and calculating the target transmission ratio based on the second wheel speed when the wheel slip occurs.

The determining of whether the wheel slip occurs may include determining that the wheel slip has occurred when the first wheel speed increases while the second wheel speed maintains its current speed, and determining that the wheel slip has not occurred when the first wheel speed and the second wheel speed are maintained the same.

The calculating of the target transmission ratio may include calculating the target transmission ratio based on either the first wheel speed or the second wheel speed and the accelerator pedal information.

The calculating of the target transmission ratio may include calculating a target transmission ratio of an automatic transmission (AT), a dual clutch transmission (DCT), or a continuously variable transmission (CVT) of the vehicle.

The transmission ratio stabilization method may further include sensing a second transmission output speed converted based on a first transmission output speed based on the drive wheel and a vehicle speed based on the non-driven wheel. The sensing of the second transmission output speed includes calculating the second transmission output speed using a final reduction ratio (FGR) and a tire dynamic radius based on the vehicle speed based on the non-driven wheel, and the second transmission output speed may be a virtual driven pulley speed value.

The calculating of the target transmission ratio may include calculating, as the target transmission ratio, a value by dividing a first target drive pulley speed calculated based on the first wheel speed and the accelerator pedal information by a drive wheel reference vehicle speed or the first transmission output speed, when the wheel slip does not occur.

The calculating of the target transmission ratio may further include calculating, as the target transmission ratio, a value by dividing a second target drive pulley speed calculated based on the second wheel speed and the accelerator pedal information by the vehicle speed based on the non-driven wheel, when the wheel slip occurs.

The calculating of the target transmission ratio may further include calculating, as the target transmission ratio, a value by dividing a second target drive pulley speed calculated based on the second wheel speed and the accelerator pedal information by the second transmission output speed, when the wheel slip occurs.

According to the transmission ratio stabilization apparatus and method on low friction roads according to an embodiment of the present disclosure, by facilitating the traction control system (TCS) control on the low friction roads, it is possible to reduce the wheel slip amount and improve the driver's drivability.

According to the transmission ratio stabilization apparatus and method on low friction roads according to an embodiment of the present disclosure, it is possible to improve the driving stability and fuel efficiency by reducing gear shift frequency on the low friction roads, maintain the acceleration when re-entering onto the low friction roads, and improve the drivability.

### BRIEF DESCRIPTION OF THE DRAWINGS

FIG. 1 is a block diagram of a transmission ratio stabilization apparatus on low friction roads according to an exemplary embodiment of the present disclosure.

FIG. 2 is a flowchart of a transmission ratio stabilization method on low friction roads according to an exemplary embodiment of the present disclosure.

FIG. 3 is a graph for describing a method of calculating a target transmission ratio according to an exemplary embodiment of the present disclosure.

FIG. 4 is a diagram for describing a method of calculating a target transmission ratio during wheel slip according to an exemplary embodiment of the present disclosure.

FIGS. 5A and 5B are graphs for describing a problem according to Comparative Example.

FIG. 6 is a graph for describing the effect of a transmission ratio stabilization apparatus and method on low friction roads according to an exemplary embodiment of the present disclosure.

### DETAILED DESCRIPTION

Hereinafter, some embodiments of the present disclosure are described more fully with reference to the accompanying drawings so as to be easily practiced by those having ordinary skill in the art to which the present disclosure pertains. As those having ordinary skill in the art would realize, the described embodiments may be modified in various different ways, all without departing from the spirit or scope of the present disclosure. Accordingly, the drawings and description are to be regarded as illustrative in nature and not restrictive. Like reference numerals designate like elements throughout the specification.

Throughout the specification and claims, unless explicitly described to the contrary, the word “comprise” and variations such as “comprises” or “comprising”, should be understood to imply the inclusion of stated elements but not the exclusion of any other elements. Terms including an ordinal number such as first, second, etc., may be used to describe various components, but the components are not limited to these terms. The above terms are used solely for the purpose of distinguishing one component from another.

In the present disclosure, each of phrases such as “A or B”, “at least one of A and B”, “at least one of A or B”, “A, B or C”, “at least one of A, B and C”, and “at least one of A, B or C” may include any one or all possible combinations of the items listed together in the corresponding one of the phrases.

Terms such as “ . . . unit”, “ . . . er/or”, and “module” used in the specification may mean a unit capable of processing at least one function or operation described in the specification, which may be implemented as hardware (e.g., a processor) or a circuit, software, or a combination of hardware or circuit and software. When a component, device, element, or the like of the present disclosure is described as having a purpose or performing an operation, function, or the like, the component, device, or element should be considered herein as being “configured to” meet that purpose or to perform that operation or function.

Hereinafter, some embodiments of the present disclosure are described with reference to the drawings.

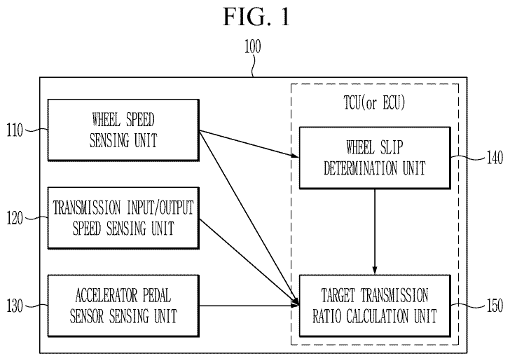

FIG. 1 is a block diagram of a transmission ratio stabilization apparatus on low friction roads according to an embodiment of the present disclosure.

According to an embodiment, A transmission ratio stabilization apparatus 100 on low friction roads may determine a target transmission ratio based on a vehicle speed based on a non-driven wheel of a vehicle when wheel slip occurs, thereby maintaining the transmission ratio to be the same as before the wheel slip occurs.

The vehicle speed based on the non-driven wheel may correspond to an actual driving speed of a vehicle determined by measuring a speed of a wheel (non-driven wheel) other than the drive wheel.

Referring to FIG. 1, the transmission ratio stabilization apparatus 100 on low friction roads includes a wheel speed sensing unit 110, a transmission input and output speed sensing unit (hereinafter “transmission input/output speed sensing unit”) 120, an accelerator sensing unit 130, a wheel slip determination unit 140, and a target transmission ratio calculation unit 150.

The wheel speed sensing unit 110 may sense a first wheel speed of the drive wheel and a second wheel speed of the non-driven wheel, respectively. For example, in a front wheel drive vehicle, the drive wheel may be a front wheel and the non-driven wheel may be a rear wheel.

The transmission input/output speed sensing unit 120 may sense the first transmission output speed based on the drive wheel and the second transmission output speed converted based on the vehicle speed based on the non-driven wheel.

Here, the second transmission output speed may be a virtual driven pulley speed value. The driven pulley speed value may refer to a rotation speed of the driven pulley. The driven pulley generally receives power from a drive pulley and rotates. The driven pulley speed is determined by the speed and the gear ratio (or transmission ratio, pulley ratio, belt ratio) of the drive pulley.

The transmission input/output speed sensing unit 120 calculates a second transmission output speed using a final gear ratio (FGR) and a tire dynamic radius based on the vehicle speed based on the non-driven wheel.

For example, the transmission input/output speed sensing unit 120 may calculate the second transmission output speed using Equation 1.

$$N = \frac{V \times F G R}{T D R} \qquad [ Equation 1 ]$$

Here, N may denote the second transmission output speed, V may denote the vehicle speed based on the non-driven wheel, FGR may denote a final gear ratio (FGR), and TDR may denote a tire dynamic radius.

The final reduction ratio may refer to a final gear ratio that transfers power transmitted through the transmission to wheels, including drive and non-drive wheels, of the vehicle. Unlike an outer diameter of the tire, the tire dynamic radius indicates a distance or a radius between a ground surface and a road surface while the tire rotates during actual driving.

The accelerator sensing unit 130 may be an accelerator pedal sensor. The accelerator refers to the accelerator pedal of the vehicle. The accelerator pedal sensor may measure the position or angle of the accelerator pedal. The data or information received from the accelerator sensing unit 130 (“accelerator pedal information”) indicates the degree to which the accelerator pedal is pressed, i.e., the amount of power or acceleration the driver of the vehicle desires.

The accelerator pedal sensor reflects a driver's intent. In other words, the accelerator pedal sensor may indicate the extent to which the driver intends to accelerate the vehicle.

The wheel slip determination unit 140 may determine whether the wheel slip occurs based on at least one of the first wheel speed or the second wheel speed. The wheel slip determination unit 140 determines whether the wheel slip occurs based on the sensed wheel speed(s).

The wheel slip refers to a phenomenon in which a wheel loses contact with a road surface and spins or slips. It mainly occurs when the rotation speed of the wheel on the low friction roads does not match the ground surface speed of the road or becomes faster than that. The low friction road refers to a situation where a road surface is slippery or has low grip, resulting in a reduction of the frictional force between the tires of the vehicle and the road.

The wheel slip determination unit 140 may refer to a part, which determines the wheel slip, within a transmission control unit (TCU) or an engine control unit (ECU).

In an embodiment, the wheel slip determination unit 140 determines that the wheel slip occurs when the first wheel speed increases while the second wheel speed maintains its current speed on the low friction road.

The wheel slip determination unit 140 determines that the wheel slip does not occur when the first wheel speed and the second wheel speed are maintained the same level.

The wheel slip determination unit 140 may determine that the wheel slip has occurred when the difference between the first wheel speed and the second wheel speed is greater than a certain value (a preset reference value).

In one embodiment, the wheel slip determination unit 140 may determine that the wheel slip has not occurred when the difference between the first wheel speed and the second wheel speed is less than (or less than or equal to) a certain value.

The target transmission ratio calculation unit 150 may refer to a part, which calculates the target transmission ratio, within the transmission control unit (TCU) or the engine control unit (ECU).

The target transmission ratio (target gear ratio) may refer to a ratio for achieving desired performance under specific driving conditions by setting the transmission ratio (gear ratio) provided by each gear in the vehicle transmission.

The transmission ratio refers to the ratio of the speed and rotation speed at which the rotation speed of the engine is transmitted to the wheels through the transmission. The transmission ratio of the transmission may represent a comprehensive gear ratio including the gear ratio of each gear and the final drive ratio of the vehicle.

The target transmission ratio calculation unit 150 may calculate a target transmission ratio of an automatic transmission (AT), a dual clutch transmission (DCT), and a continuously variable transmission (CVT), among various transmissions.

The automatic transmission (AT) has a fixed gear ratio, and may calculate the transmission output speed at each gear stage. In the automatic transmission, the transmission output speed may vary depending on the gear ratio.

The dual clutch transmission (DCT) performs gear shifting by operating two clutches alternately. One clutch is responsible for odd gears, and the other is responsible for even gears.

The continuously variable transmission (CVT) may continuously adjust the gear ratio by using two circular pulleys and a belt (or chain) connecting them.

The target transmission ratio calculation unit 150 calculates the target transmission ratio based on the first wheel speed when the wheel slip does not occur.

The target transmission ratio calculation unit 150 calculates the target transmission ratio based on the second wheel speed when the wheel slip occurs.

The target transmission ratio calculation unit 150 may calculate the target transmission ratio based on either the first wheel speed or the second wheel speed and the information received from the accelerator pedal sensor (hereinafter “accelerator pedal sensor information”).

In other words, the target transmission ratio calculation unit 150 calculates the target transmission ratio based on the first wheel speed and the accelerator pedal sensor information when the wheel slip does not occur. The target transmission ratio calculation unit 150 calculates the target transmission ratio based on the second wheel speed and the accelerator pedal sensor information when the wheel slip occurs.

In an embodiment, the target transmission ratio calculation unit 150 may calculate, as the target transmission ratio, the value by dividing the first target drive pulley speed calculated based on the first wheel speed and the accelerator pedal sensor information by the vehicle speed or the first transmission output speed based on the drive wheel when the wheel slip does not occur.

The target transmission ratio calculation unit 150 may calculate, as the target transmission ratio, a value by dividing the second target drive pulley speed calculated based on the second wheel speed and the accelerator pedal sensor information by the vehicle speed based on the non-driven wheel when the wheel slip occurs.

Alternatively, the target transmission ratio calculation unit 150 may calculate, as the target transmission ratio, a value by dividing the second target drive pulley speed calculated based on the second wheel speed and the accelerator pedal sensor information by the second transmission output speed when the wheel slip occurs. The second transmission output speed may be a virtual driven pulley speed value converted based on the vehicle speed based on the non-driven wheel.

The target drive pulley speed may refer to the rotation speed that the drive pulley (input pulley) targets in a continuously variable transmission (CVT).

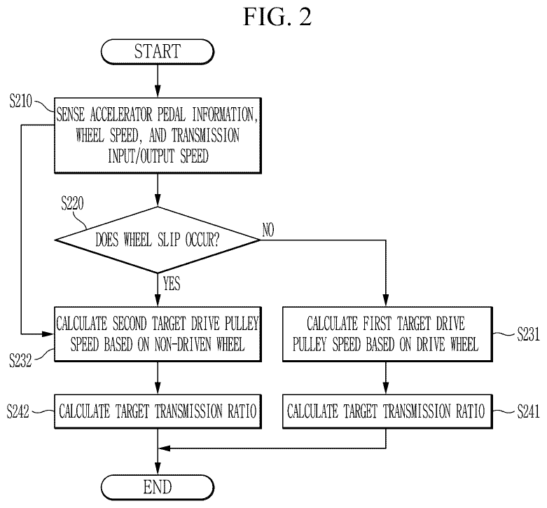

FIG. 2 is a flowchart of a transmission ratio stabilization method on low friction roads according to an embodiment of the present disclosure. A transmission ratio stabilization method on low friction roads of FIG. 2 may be performed through the transmission ratio stabilization apparatus 100 on low friction roads of FIG. 1. The transmission ratio stabilization method on low friction roads of FIG. 2 includes a method of calculating a target transmission ratio of a continuously variable transmission (CVT).

In FIG. 2, the transmission ratio stabilization apparatus 100 on low friction roads may sense the first wheel speed of the drive wheel and the second wheel speed of the non-driven wheel of the vehicle, respectively (step S210). The vehicle speed based on the drive wheel is calculated based on the first wheel speed. The vehicle speed based on the non-driven wheel is calculated based on the second wheel speed.

The transmission ratio stabilization apparatus 100 may include the accelerator pedal sensor to provide accelerator pedal information, indicating the driver's intention to accelerate the vehicle (step S210).

The transmission ratio stabilization apparatus 100 may sense the transmission input/output speed (step S210).

The transmission ratio stabilization apparatus 100 may determine whether the wheel slip occurs based on at least one of the first wheel speed or the second wheel speed (step S220). The transmission ratio stabilization apparatus 100 may determine whether the wheel slip occurs, through the wheel speed sensed in the TCU or ECU, on the low friction roads.

The transmission ratio stabilization apparatus 100 may determine that the wheel slip occurs when the first wheel speed increases while the second wheel speed maintains the existing speed (i.e., its current speed) on the low friction roads. The transmission ratio stabilization apparatus 100 may determine that the wheel slip does not occur when the first wheel speed and the second wheel speed are maintained the same or similar level on the low friction roads.

The transmission ratio stabilization apparatus 100 may determine that the wheel slip occurs when the difference between the first wheel speed and the second wheel speed is greater than a certain value (reference value).In one embodiment, the transmission ratio stabilization apparatus 100 may determine that the wheel slip does not occur when the difference is less than (or less than or equal to) the certain value.

The transmission ratio stabilization apparatus 100 may calculate the target transmission ratio based on either the first wheel speed or the second wheel speed and the accelerator pedal sensor information.

The transmission ratio stabilization apparatus 100 may calculate a first target drive pulley speed based on the drive wheel when the wheel slip does not occur (step S231).

The target drive pulley speed may refer to the rotation speed that the drive pulley targets in the continuously variable transmission (CVT). When the wheel slip does not occur, the first target drive pulley speed may be calculated based on the vehicle speed based on the drive wheel, the final drive ratio, and the tire dynamic radius.

The transmission ratio stabilization apparatus 100 may calculate the target transmission ratio based on the first wheel speed when the wheel slip does not occur (step S241).

In other words, the transmission ratio stabilization apparatus 100 may calculate, as the target transmission ratio, a value by dividing the first target drive pulley speed by the vehicle speed or the first transmission output speed based on the drive wheel when the wheel slip does not occur.

The transmission ratio stabilization apparatus 100 may calculate the second target drive pulley speed based on the non-driven wheel (step S232).

The transmission ratio stabilization apparatus 100 may sense the second transmission output speed converted based on the first transmission output speed based on the drive wheel and the vehicle speed based on the non-driven wheel.

The transmission ratio stabilization apparatus 100 may calculate the second transmission output speed, which is a virtual driven pulley speed value, using the final gear ratio (FGR) and the tire dynamic radius.

The transmission ratio stabilization apparatus 100 may calculate the second target drive pulley speed based on the vehicle speed based on the non-driven wheel, the final drive ratio, and the tire dynamic radius when the wheel slip occurs.

The transmission ratio stabilization apparatus 100 may calculate the target transmission ratio based on the second wheel speed when the wheel slip occurs (step S242).

In other words, when the wheel slip occurs, the transmission ratio stabilization apparatus 100 may calculate, as the target transmission ratio, a value by dividing the second target drive pulley speed by the vehicle speed based on the non-driven wheel or the second transmission output speed.

In an embodiment, the transmission ratio stabilization apparatus 100 may constantly calculate the target transmission ratio based on the second wheel speed and the accelerator pedal sensor information according to user settings, regardless of whether the wheel slip occurs.

In other words, the driver of the vehicle may set the vehicle speed of the non-driven wheel to be used when calculating the target transmission ratio, and the transmission ratio stabilization apparatus 100 may constantly calculate the target transmission ratio based on the second wheel speed and the accelerator pedal sensor information, according to the driver's settings.

In another embodiment, the transmission ratio stabilization apparatus 100 may calculate the target transmission ratio based on the second wheel speed and the accelerator pedal sensor information when the entry of the vehicle onto the low friction roads is detected, regardless of whether wheel slip occurs.

The transmission ratio stabilization apparatus 100 may detect whether the vehicle has entered onto the low friction roads using wheel speed sensors, a vehicle stability control system (VSC), driving condition data analysis, a tire pressure monitoring system (TPMS), or the like.

The transmission ratio stabilization apparatus 100 may continuously calculate the target transmission ratio based on the second wheel speed and the accelerator pedal sensor information when the vehicle has entered onto the low friction road(s) using various sensors in the vehicle, regardless of whether the wheel slip occurs.

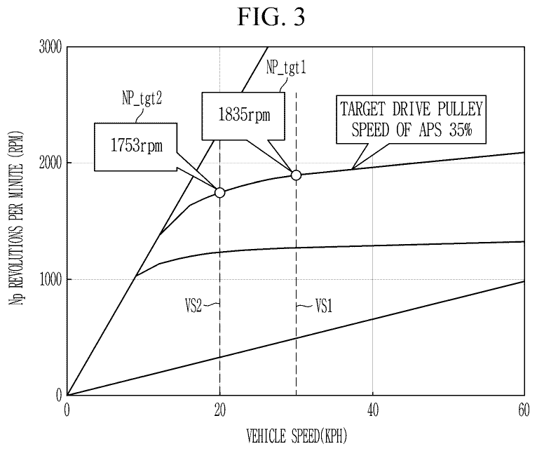

FIG. 3 is a graph for describing a method of calculating a target transmission ratio according to an embodiment of the present disclosure.

FIG. 3 illustrates the target drive pulley speed according to a vehicle speed VS1 based on the drive wheel and a vehicle speed VS2 based on the non-driven wheel of a vehicle, respectively.

FIG. 3 is a graph showing a vehicle speed and a target drive pulley speed “NP_tgt” in a situation where wheel slip occurs while the vehicle is driving at 20 kph by pressing an accelerator at 30%, causing the vehicle speed VS1 based on the drive wheel to momentarily increase to 30 kph, and the vehicle speed VS2 based on the non-driven wheel is maintained at 20 kph.

When wheel slip does not occur, the target drive pulley speed of the vehicle appears as 1753 rpm because the accelerator pedal sensor (APS) is 35% and both the vehicle speed based on the drive wheel and the vehicle speed based on the non-driven wheel are 20 kph.

In FIG. 3, the first target drive pulley speed NP_tgt1 is calculated based on the vehicle speed VS1 based on the drive wheel and the accelerator pedal sensor (APS) information.

For example, when the vehicle speed VS1 based on the drive wheel is 30 kph and the accelerator pedal sensor (APS) information is 35%, the first target drive pulley speed NP_tgt1 is 1895 rpm.

The second target drive pulley speed NP_tgt2 is calculated based on the vehicle speed VS2 based on the non-driven wheel and the accelerator pedal sensor (APS) information.

For example, when the vehicle speed VS2 based on the non-driven wheel is 20 kph and the accelerator pedal sensor (APS) information is 35%, the second target drive pulley speed NP_tgt2 is 1753 rpm.

Therefore, when the first target drive pulley speed is calculated based on the drive wheel when the wheel slip occurs, the calculated first target drive pulley speed NP_tgt1 has a different value from the target drive pulley speed when the wheel slip does not occur.

However, when the second target drive pulley speed is calculated based on the non-driven wheel when the wheel slip occurs, the calculated second target drive pulley speed NP_tgt2 has the same value as the target drive pulley speed when the wheel slip does not occur.

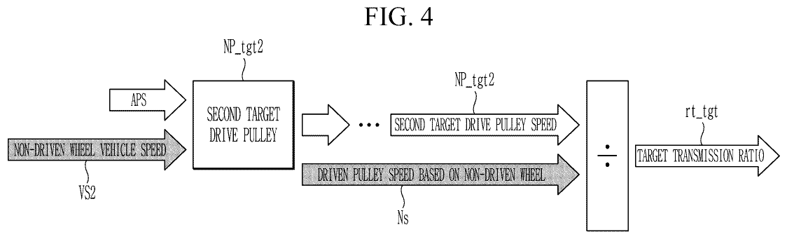

FIG. 4 is a diagram for describing a method of calculating a target transmission ratio during wheel slip according to an embodiment of the present disclosure. The description is provided with reference to FIG. 3.

The transmission ratio stabilization apparatus 100 may calculate, as the target transmission ratio, a value by dividing the first target drive pulley speed calculated based on the first wheel speed and the accelerator pedal sensor information by the vehicle speed or the first transmission output speed based on the drive wheel when the wheel slip does not occur.

In FIG. 4, the transmission ratio stabilization apparatus 100 may calculate the second target drive pulley speed NP_tgt2 based on the accelerator pedal sensor (APS) information and the vehicle speed VS2 based on the non-driven wheel when the wheel slip occurs.

The transmission ratio stabilization apparatus 100 may calculate a target transmission ratio rt_tgt by dividing the second target drive pulley speed by the driven pulley speed based on the non-driven wheel.

The driven pulley speed based on the non-driven wheel may correspond to a second transmission output speed Ns converted based on the non-driven wheel. The second transmission output speed Ns may be calculated based on the vehicle speed based on the non-driven wheel using the final gear ratio (FGR) and the tire dynamic radius. For example, the second transmission output speed Ns converted based on the second wheel speed based on the non-driven wheel may be 851 rpm.

Therefore, when the second target drive pulley speed NP_tgt2 is 1753 rpm at a vehicle speed of 20 kph and an accelerator pedal sensor information is 35%, the target transmission ratio rt_tgt is 1753/851, and therefore, is 2.060. When the accelerator pedal is fully pressed (100%), it represents the maximum input from the driver, demanding full acceleration. Here, the 35% indicates the degree of the accelerator pedal depression as 35% relative to its full (100%) depression.

Since the target transmission ratio during driving is 2.060 when the wheel slip does not occur, the target transmission ratio calculated based on the non-driven wheel when the wheel slip occurs is maintained the same as the target transmission ratio during driving when the wheel slip does not occur.

Therefore, the transmission ratio stabilization apparatus 100 may implement the stabilization by maintaining the transmission ratio as it is on low friction roads.

The first transmission output speed converted based on the first wheel speed of the drive wheel may be 1276 rpm. When the wheel slip occurs, the target transmission ratio calculated based on the driven wheel is 1895/1276, and therefore, is 1.485. Therefore, in the case of the existing Comparative Example, it may be seen that the transmission ratio is upshifted and unstable when the wheel slip occurs.

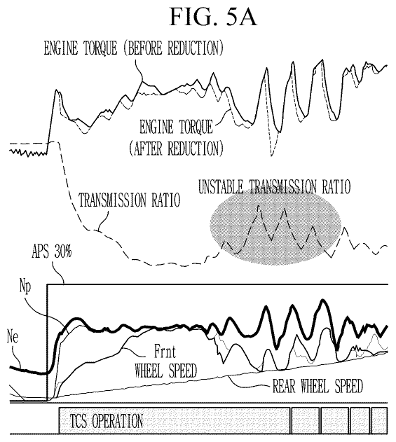

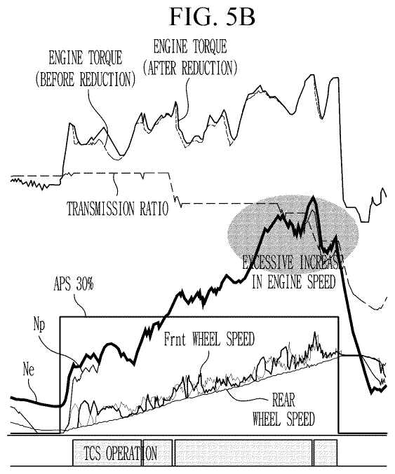

FIGS. 5A and 5B are graphs for describing a problem according to Comparative Example. FIG. 5A and FIG. 5B illustrate instability when the target transmission ratio is determined based on the drive wheel when the wheel slip occurs.

FIG. 5A illustrates the case where the target transmission ratio is determined based on the drive wheel when the wheel slip occurs and the transmission ratio is not forcibly fixed. In other words, the transmission ratio may be up-shifted when the wheel slip occurs. In other words, when the transmission ratio changes due to the wheel slip and the wheel slip is reduced and a shift to a lower gear occurs again, the driving force and transmission ratio become very unstable because the transmission ratio changes according to the wheel slip.

In FIG. 5A, when the wheel slip occurs and the up-shifting occurs, the driving force decreases and the wheel slip tends to decrease, so the transmission ratio also continues to repeatedly up-shift and down-shift, thereby making the amount of wheel slip unstable.

An engine speed Ne and a drive pulley speed Np show unstable waves when the wheel slip occurs. The drive wheel speed (Frnt wheel speed) increases rapidly when the wheel slip occurs, and the non-driven wheel speed (rear wheel speed) is stable.

It may be seen that the transmission ratio is also unstable when the wheel slip is unstable. Therefore, it is difficult to control the target transmission ratio according to the wheel slip.

Comparative Example of FIG. 5B is a case where the transmission ratio is forcibly fixed when the wheel slip occurs.

In FIG. 5B, it may be seen that the wheel slip is stabilized by forcibly fixing the transmission ratio. However, compared to a usual friction road, the engine speed “Ne” and the drive pulley speed “Np” increase significantly relative to the driver's acceleration intent on the current low friction road. In other words, Comparative Example of FIG. 5B has a problem that the driver's intent is not reflected due to the fixation of the transmission ratio.

Comparative Example of FIG. 5B has a problem that the RPM of the engine speed increases excessively due to the high pulley ratio maintained by the continuous fixation of the pulley ratio by the traction control system (TCS) and the gear shift control (GSC).

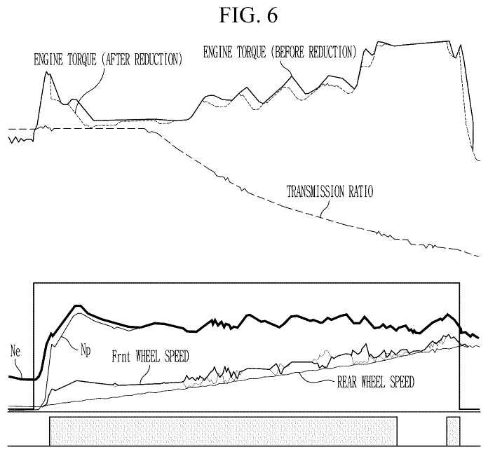

FIG. 6 is a graph for describing the effect of a transmission ratio stabilization apparatus and method on low friction roads according to an embodiment of the present disclosure.

The transmission ratio stabilization apparatus 100 generates pulley shifting according to the driver's will (i.e., intent) when the wheel slip occurs on a low friction road, and controls the transmission ratio and the wheel slip most stably.

In FIG. 6, it may be seen that the transmission ratio is stable, the drive wheel speed (Frnt wheel speed) and the non-driven wheel speed (rear wheel speed) are stable, and the engine speed Ne and the drive pulley speed Np are also stable.

In addition, it may be seen that the embodiment of FIG. 6 is the most advantageous in terms of the wheel slip target control in the TCS.

In other words, the transmission ratio stabilization apparatus 100 according to the present disclosure stabilizes the transmission ratio even when the wheel slip occurs on the low friction roads, thereby stabilizing the wheel slip and controlling the engine speed as desired like the flat ground.

The transmission ratio stabilization apparatus 100 may improve all items including the drivability, the fuel efficiency, and the noise compared to Comparative Example.

Although embodiments of the present disclosure have been described in detail hereinabove, the scope of the present disclosure is not limited thereto, but may include several modifications and alterations made by those having ordinary skill in the art to which the present disclosure pertains using a basic concept of the present disclosure as defined in the claims.

### DESCRIPTION OF SYMBOLS

100: Transmission ratio stabilization apparatus on low friction roads
110: Wheel speed sensing unit
120: Transmission input/output speed sensing unit
130: Accelerator opening sensing unit
140: Wheel sleep determination unit
150: Target transmission ratio calculation unit

What is claimed is:

1. A transmission ratio stabilization apparatus comprising:
a wheel speed sensing unit configured to sense a first wheel speed of a drive wheel and a second wheel speed of a non-driven wheel, respectively, in a vehicle;
an accelerator sensing unit configured to provide an accelerator pedal information of the vehicle;
a wheel slip determination unit configured to determine whether wheel slip occurs based on the first wheel speed and the second wheel speed; and
a target transmission ratio calculation unit configured to calculate: a target transmission ratio based on the first wheel speed when the wheel slip does not occur and configured to calculate the target transmission ratio based on the second wheel speed when the wheel slip occurs.

2. The transmission ratio stabilization apparatus of claim 1, wherein:
the wheel slip determination unit is configured to determine that the wheel slip has occurred when the first wheel speed increases while the second wheel speed maintains a current speed thereof, and
the wheel slip determination unit is configured to determine that the wheel slip has not occurred when the first wheel speed and the second wheel speed are maintained the same.

3. The transmission ratio stabilization apparatus of claim 1, wherein:
the target transmission ratio calculation unit is configured to calculate the target transmission ratio based on either the first wheel speed or the second wheel speed and the accelerator pedal information.

4. The transmission ratio stabilization apparatus of claim 1, wherein:
the target transmission ratio calculation unit is configured to calculate a target transmission ratio of an automatic transmission (AT), a dual clutch transmission (DCT), or a continuously variable transmission (CVT) of the vehicle.

5. The transmission ratio stabilization apparatus of claim 1, further comprising:
a transmission input/output speed sensing unit is configured to sense a first transmission output speed and a second transmission output speed based on the drive wheel,
wherein the transmission input/output speed sensing unit is configured to calculate a second transmission output speed, which is a virtual driven pulley speed value, using a final gear ratio (FGR) and a tire dynamic radius based on a vehicle speed based on the non-driven wheel.

6. The transmission ratio stabilization apparatus of claim 5, wherein:
when the wheel slip does not occur, the target transmission ratio calculation unit is configured to calculate, as the target transmission ratio, a value by dividing a first target drive pulley speed calculated based on the first wheel speed and the accelerator pedal information by a vehicle speed or the first transmission output speed based on the drive wheel.

7. The transmission ratio stabilization apparatus of claim 6, wherein:
when the wheel slip occurs, the target transmission ratio calculation unit is configured to calculate, as the target transmission ratio, a value by dividing a second target drive pulley speed calculated based on the second wheel speed and the accelerator pedal information by the vehicle speed based on the non-driven wheel.

8. The transmission ratio stabilization apparatus of claim 6, wherein:
when the wheel slip occurs, the target transmission ratio calculation unit is configured to calculate, as the target transmission ratio, a value by dividing a second target drive pulley speed calculated based on the second wheel speed and the accelerator pedal information by the second transmission output speed.

9. A transmission ratio stabilization method on low friction roads, comprising:
sensing a first wheel speed of a drive wheel and a second wheel speed of a non-driven wheel, respectively, in a vehicle;
providing accelerator pedal information corresponding to vehicle acceleration desired by a driver of the vehicle;
determining whether wheel slip occurs based on the first wheel speed and the second wheel speed; and
calculating a target transmission ratio based on the first wheel speed when the wheel slip does not occur, and calculating the target transmission ratio based on the second wheel speed when the wheel slip occurs.

10. The transmission ratio stabilization method of claim 9, whereindetermining whether the wheel slip occurs includes:
determining that the wheel slip has occurred when the first wheel speed increases while the second wheel speed maintains a current speed thereof, and determining that the wheel slip has not occurred when the first wheel speed and the second wheel speed are maintained the same.

11. The transmission ratio stabilization method of claim 9, wherein calculating the target transmission ratio includes:
calculating the target transmission ratio based on either the first wheel speed or the second wheel speed and the accelerator pedal information.

12. The transmission ratio stabilization method of claim 9, wherein calculating the target transmission ratio includes:
calculating a target transmission ratio of an automatic transmission (AT), a dual clutch transmission (DCT), or a continuously variable transmission (CVT) of the vehicle.

13. The transmission ratio stabilization method of claim 9, further comprising:
sensing a second transmission output speed converted based on a first transmission output speed based on the drive wheel and a vehicle speed based on the non-driven wheel,
wherein sensing the second transmission output speed includes:
calculating the second transmission output speed using a final reduction ratio (FGR) and a tire dynamic radius based on the vehicle speed based on the non-driven wheel, and
wherein the second transmission output speed is a virtual driven pulley speed value.

14. The transmission ratio stabilization method of claim 13, wherein calculating the target transmission ratio includes:
calculating, as the target transmission ratio, a value by dividing a first target drive pulley speed calculated based on the first wheel speed and the accelerator pedal information by a vehicle speed or the first transmission output speed based on the drive wheel, when the wheel slip does not occur.

15. The transmission ratio stabilization method of claim 14, wherein calculating the target transmission ratio further includes:
calculating, as the target transmission ratio, a value by dividing a second target drive pulley speed calculated based on the second wheel speed and the accelerator pedal information by the vehicle speed based on the non-driven wheel, when the wheel slip occurs.

16. The transmission ratio stabilization method of claim 14, wherein calculating the target transmission ratio further includes:
calculating, as the target transmission ratio, a value by dividing a second target drive pulley speed calculated based on the second wheel speed and the accelerator pedal information by the second transmission output speed, when the wheel slip occurs.

17. A transmission ratio stabilization method on low friction roads, comprising:
sensing a first wheel speed of a drive wheel and a second wheel speed of a non-driven wheel, respectively, in a vehicle;
providing an accelerator pedal information corresponding to vehicle acceleration desired by a driver of the vehicle; and
calculating a target transmission ratio based on the second wheel speed and the accelerator pedal information according to a user setting or when an entry of the vehicle onto the low friction roads is detected, regardless of whether wheel slip occurs.
